(19) United States
(12) Patent Application Publication
(10) Pub. No.: US 2024/0265295 A1
(43) Pub. Date: Aug. 8, 2024

(54) DISTRIBUTED LOADING AND TRAINING FOR MACHINE LEARNING MODELS

(71) Applicant: Snap Inc., Santa Monica, CA (US)

(72) Inventors: Lin Zhong, Medina, WA (US); Artur Chakhvadze, Santa Monica, CA (US); Yang Hu, Los Angeles, CA (US)

(21) Appl. No.: 18/164,230

(22) Filed: Feb. 3, 2023

(51) Int. Cl. G06N 20/00; H04L 67/563

(52) U.S. Cl. CPC G06N 20/00; H04L 67/563

(57) ABSTRACT

One or more data loaders in a distributed computer system access input data from a storage component. A trainer in the distributed computer system transmits a training data request. The trainer and the one or more data loaders are executed on separate processors. In response to receiving, by a data loader of the one or more data loaders, the training data request, the data loader executes a data loading task to generate a training batch. The data loader transmits the training batch to the trainer. The trainer executes a training task which includes using the training batch to execute a machine learning algorithm.

### BACKGROUND

Machine learning is a field of study that gives computers the ability to learn without being explicitly programmed. Machine learning explores the study and construction of algorithms, also referred to herein as tools, that may learn from or be trained using existing data and make predictions about or based on new data.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is high-level diagrammatic representation of a distributed computer system for data loading and model training, according to some examples.

FIG. 2 is a diagrammatic representation of a distributed computer system for data loading and model training, according to some examples.

FIG. 3 is a diagrammatic representation of a control plane of a service mesh, according to some examples.

FIG. 4 is a flowchart of a method of distributed data loading and model training, according to some examples, described with reference to the example distributed computer system of FIG. 1.

FIG. 5 is a flowchart of a method of distributed data loading and model training across a service mesh to generate an object tracking model, according to some examples, described with reference to the example distributed computer system of FIG. 2.

FIG. 6 illustrates training and use of a machine-learning program, according to some examples.

FIG. 7 is a diagrammatic representation of a networked environment in which the present disclosure may be deployed, according to some examples.

FIG. 8 is a diagrammatic representation of an interaction system, according to some examples, that has both client-side and server-side functionality.

FIG. 9 is a diagrammatic representation of a data structure as maintained in a database, according to some examples.

FIG. 10 is a diagrammatic representation of a message, according to some examples.

FIG. 11 illustrates a system including a head-wearable apparatus, according to some examples.

FIG. 12 is a diagrammatic representation of a machine in the form of a computer system within which a set of instructions may be executed to cause the machine to perform any one or more of the methodologies discussed herein, according to some examples.

FIG. 13 is a block diagram showing a software architecture within which examples may be implemented.

### DETAILED DESCRIPTION

Examples of the present disclosure improve the speed and efficiency of a machine learning model building process through a horizontally distributed and scalable architecture.

Machine learning models are used across various applications. For example, in the field of object tracking, it may be useful to create a machine learning model for human hand tracking. A machine learning model for human hand tracking may, in some applications, be trained to detect certain gestures captured by a camera of a mobile or wearable device.

Building a model of this nature can be a time-consuming project, requiring both data loading and model training. For example, in some applications, a data loader application may be used to load and prepare training data, and then feed the training data, in batches, to a trainer application. The trainer provides a machine learning algorithm that iteratively learns from the training data to create the model.

In some examples, such as in the building of object tracking models, when comparing the data loading process with the training process, data loading is generally a more Central Processing Unit (CPU) intensive task than training, while training is generally a Graphics Processing Unit (GPU) intensive task. This may result in one or more technical challenges. For example, when building a human hand tracking model, the data loading process may create a bottleneck, leading to a high degree of CPU resource utilization and under-utilization of GPU resources. A data loader may, for example, be unable to generate batches of training data at a rate sufficient to saturate the GPU resources available for the training process, resulting in the training process at times being idle and ultimately delaying building or finalization of the model.

In some examples, GPU intensive model training is separated from CPU intensive data loading by implementing these respective processes on different processors, machines, or execution units (or on different processors, machines and execution units) in a distributed computer system. The processes can be connected via a service mesh architecture. A technical problem of GPU resources being underutilized, or a GPU being idle during data loading, is alleviated by deploying the distributed computer system according to examples of the present disclosure.

In some examples, a distributed computer system comprises a trainer and a plurality of data loaders serving the trainer. Workloads can be communicated to the data loaders by the trainer via Remote Procedure Calls (RPCs). Traffic management and load balancing between the trainer (e.g., a model trainer client component) and the data loaders (e.g., data loader server components) may, for example, be performed by network proxies that define a data plane of a service mesh. Some examples of the present disclosure may address a technical problem of a model building process being relatively inefficient due to a bottleneck forming at a data loading process. The architecture according to examples of the present disclosure can be used in the building of machine learning models, such as object tracking models (e.g., a machine learning model for human hand tracking or human gesture recognition).

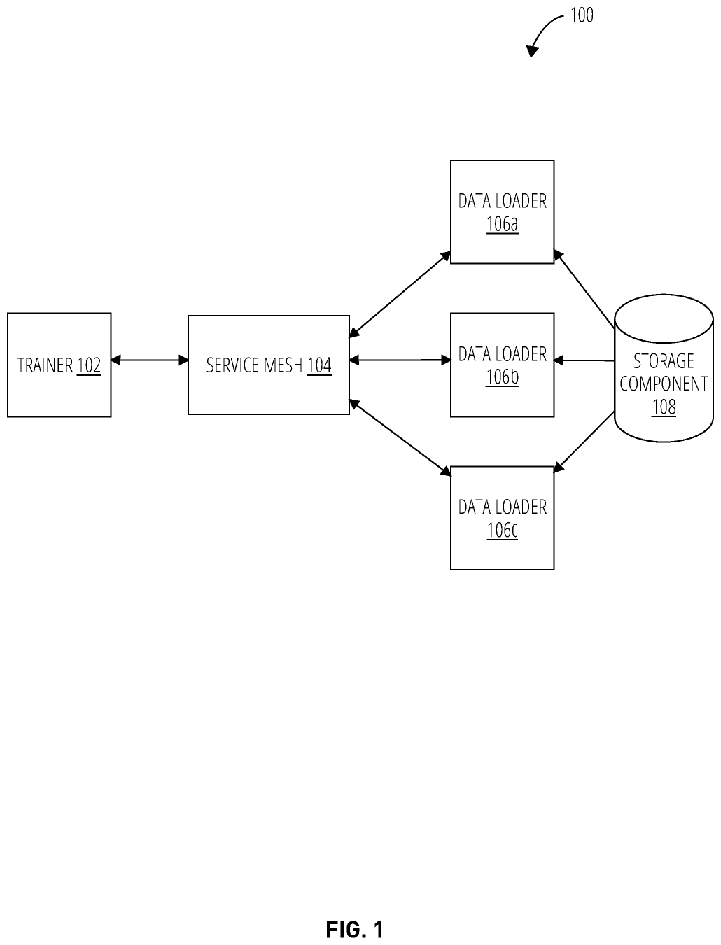

FIG. 1 is a block diagram showing a distributed computer system 100 used for building machine learning models, according to some examples. The distributed computer system 100 comprises a trainer 102 and three data loaders: data loader 106a, data loader 106b, and data loader 106c.

The trainer 102 may be configured to implement a machine learning model training application. The trainer 102 receives training data from the data loaders 106a, 106b and 106c in batches (referred to herein as training batches) and uses a machine learning algorithm to learn from the training batches in an iterative manner to construct a machine learning model, e.g., an object tracking model.

The data loaders 106a, 106b, 106c may be configured to implement a data loading application and are communicatively coupled to a storage component 108 which stores input data. The storage component 108 may be any suitable machine storage medium, e.g., cloud storage or a persistent solid-state drive (SSD) disk accessible by the data loaders 106a, 106b, 106c to read the input data. In some examples, the input data is “raw data” that needs to be processed by a data loader before it can be fed to a training program. This may be referred to as “preprocessing”, with examples of preprocessing actions described below.

When building certain types of models, such as object tracking models, training processes may be relatively GPU intensive, while data loading processes may be relatively CPU intensive. As shown in FIG. 1, the trainer 102 is separated from the data loaders 106a, 106b, 106c so as to separate CPU and GPU intensive workloads from each other. The trainer 102 and the loaders 106a, 106b, 106c (or the trainer 102 and each loader 106a, 106b, 106c) may, for example, be run on separate processors and/or machines (physical or virtual) in the distributed computer system 100, and/or on separate computing nodes. This may address, for example, a technical problem of a single machine (physical or virtual) having insufficient processing capacity to handle both CPU and GPU intensive workloads in an efficient manner. It should be appreciated that, in the context of this specification, the term “CPU” also extends to a virtual CPU, often referred to as a vCPU. References to CPU resources should thus be interpreted to extend to vCPUs to the extent applicable.

According to examples, a trainer may communicate with data loaders (and vice versa) over any suitable network, such as the Internet or a local network. As shown in FIG. 1, the trainer 102 is communicatively coupled to the data loaders 106a, 106b, 106c by way of a service mesh 104. The service mesh 104 allows for horizontal scaling of data loading processes to improve the efficiency of a model building process. Communications between the trainer 102 and the loaders 106a, 106b, 106c are effected via the service mesh architecture, as will be described in greater detail below.

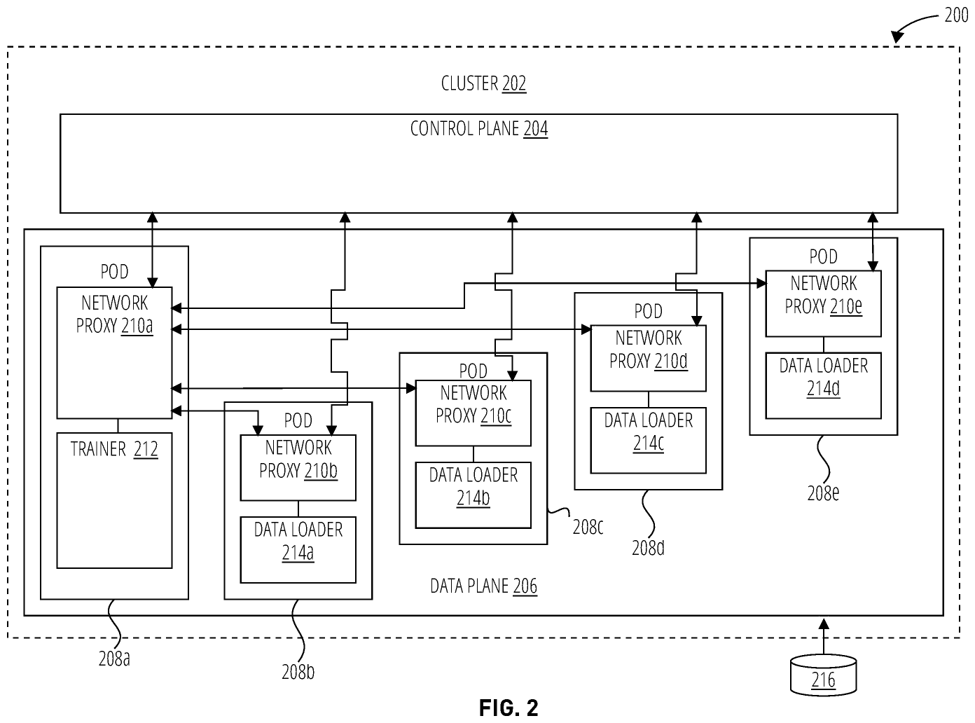

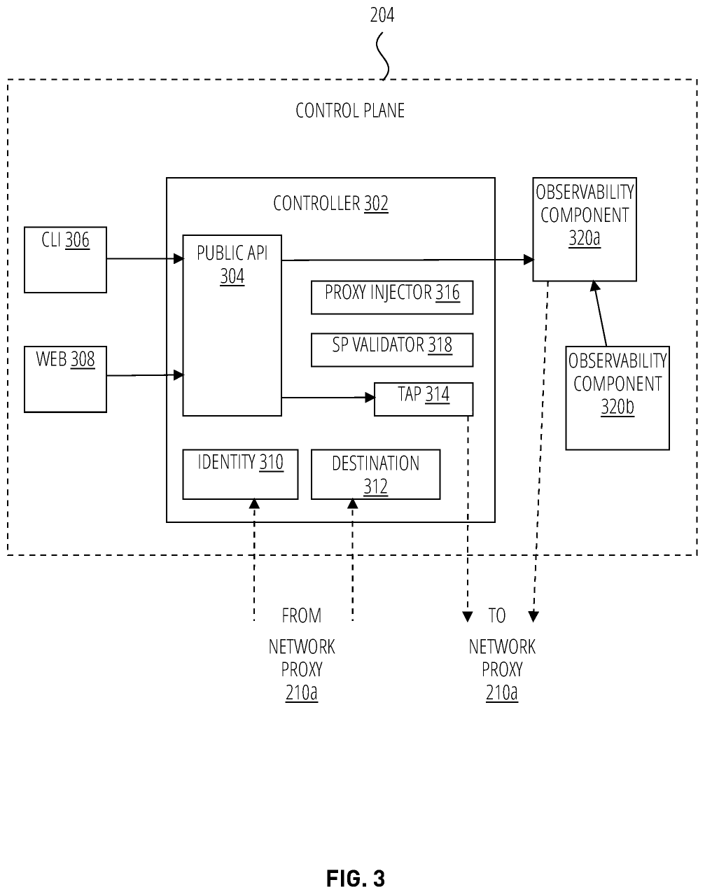

In use, the trainer 102 may transmit training data requests to the data loaders 106a, 106b, 106c. In response, the data loaders 106a, 106b, 106c preprocess input batches read from the input data in the storage component 108 to generate training batches. These training batches are fed to the trainer 102, allowing the trainer to train the machine learning model on the training batches (training data). These and other aspects are described in greater detail below, with reference to the examples shown in FIG. 2 and FIG. 3.

While one trainer 102, three data loaders 106a, 106b, 106c and one storage component 108 are shown in FIG. 1, it should be appreciated that some examples may include more, or less, data loaders, more trainers, more storage components, or a combination thereof. For example, it may be desirable to use a service mesh architecture to scale not only data loaders horizontally, but also trainers.

FIG. 2 is a block diagram showing further details of a distributed computer system 200 for machine learning model building, according to some examples. The distributed computer system 200 is shown to comprise a cluster 202 which includes a number of components, as will be described below, and an external storage component 216 communicatively coupled to the cluster 202. The external storage component 216 may be similar to the storage component 108 described with reference to FIG. 1.

The cluster 202 provides a set of computing nodes that run containerized applications. Kubernetes™ is an example of an open-source system for deployment of clusters of this nature. Generally, clusters allow containers to run across multiple machines and environments: virtual, physical, cloud-based, or on-premises. The containers are not restricted to a specific operating system, unlike traditional virtual machines. The “nodes” are the components that run the applications in the cluster 202. They can either be virtual machines or physical computers, all operating as part of one system. A cluster thus provides a node pool, which is a pool of resources applied as needed to run cluster components.

The individual execution units in the cluster 202 may be referred to as “pods.” As shown in FIG. 2, the cluster 202 includes five pods 208a, 208b, 208c, 208d, 208e. A pod may, generally, encapsulate one or more applications. Pods may be ephemeral by nature, meaning that if a pod (or the node it executes on) fails, a new replica of that pod can automatically be created to continue operations.

Turning now more specifically to the pods present in FIG. 2, the pod 208a includes a containerized application in the form of a trainer 212 and further includes a proxy container referred to as a network proxy 210a. The pods 208b, 208c, 208d, 208e each include a containerized application in the form of a data loader 214a, 214b, 214c, 214d. In FIG. 2, there is a one-to-many relationship between the trainer 212 and the data loader 214a, 214b, 214c, 214d, with the data loaders 214a, 214b, 214c, 214d providing multiple instances of a data loader application or service. The data loaders 214a, 214b, 214c, 214d may be similar to the data loaders 106a, 106b, 106c described with reference to FIG. 1, and the trainer 212 may be similar to the trainer 102 described with reference to FIG. 1. In some examples, and as shown in FIG. 2, each data loader may be a separate instance contained in its own pod. Alternatively, a pod may include multiple data loaders operating as separate instances. While the trainer 212 and the data loaders data loaders 214a, 214b, 214c, 214d are shown in FIG. 2 as being deployed in the same cluster 202, in other examples a trainer may be deployed in a different cluster or otherwise be deployed “outside” of the cluster contained the data loader/s.

Each pod 208b, 208c, 208d, 208e further includes a network proxy 210b, 210c, 210d, 210e. Network proxies may be injected into pods as so-called “sidecars.” The network proxies 210a, 210b, 210c, 210d, 210e define a data plane 206 in the cluster 202. A control plane 204 is provided and is communicatively coupled to each of the network proxies 210a, 210b, 210c, 210d, 210e. A control plane according to some examples is described in greater detail with reference to FIG. 3.

The data plane 206 and the control plane 204 define a service mesh. The service mesh may be summarized as adding a layer to the cluster 202 at pod level, and is configured (among other things) to manage traffic flow between the pod 208a, which houses the trainer 212, and the other pods 208b, 208c, 208d, 208e, which house the data loaders 214a, 214b, 214c, 214d. Examples of platforms that may be used to define and/or deploy a service mesh include Istio™ and Linkerd™.

Each pod in the cluster 202 therefore has a network proxy uniquely associated with it. The data plane 206 provides these network proxies that “sit in between” the relevant applications (being the trainer 212 and the data loaders 214a, 214b, 214c, 214d, in the configuration shown in FIG. 2), and the control plane 204 is configured to control the functioning of the network proxies and to provide an interface for users operating the service mesh.

When defining a service mesh between applications, or services, the applications or services do not communicate with each other directly, but rather do so through the network proxies. In other words, the network proxies 210a, 210b, 210c, 210d, 210e intercept and manage communications between the trainer 212, which may be regarded as a client application, and the data loaders 214a, 214b, 214c, 214d, which may be regarded as server applications. The network proxies 210a, 210b, 210c, 210d, 210e may be configured, for example, to perform request level load balancing and implement retries. The functionality of the network proxies is further described below.

The distributed computer system 200 may be used in a model building process, e.g., to build an object tracking model. When constructing models of this nature, it may be desirable to maximize the utilization of GPU resources in the distributed computer system 200. This can be facilitated by deploying the trainer 212 and allocating the GPU resources in the distributed computer system 200 to the trainer 212, while horizontally scaling the CPU intensive data loaders 214a, 214b, 214c, 214d serving the trainer 212. Examples of the present disclosure utilize an architecture such as the one shown in FIG. 2 to optimize or improve CPU and input/output (I/O) performance while achieving or maintaining desired GPU throughout.

In FIG. 2, the distributed computer system 200 comprises a single cluster 202. It should be appreciated that, in other examples, a service mesh may be distributed across multiple clusters. Further, while one trainer, four data loaders and one external storage are shown in FIG. 2, it should be appreciated that some examples may include more, or less, data loaders, more trainers, more storage components, or a combination thereof.

A distributed computer system may thus be designed and scaled so as to achieve a required, or optimal, resource utilization or throughput. For example, to build a certain object tracking model (e.g., a hand tracking model or gesture detection model), it may be desirable to deploy a total of six pods similar to the pod 208b, each containing a data loader. These six pods can then be allocated sufficient CPU resources to saturate, for example, a single trainer with a total of 8 NVIDIA™ “V100 Tensor Core” data center GPUs. For example, each pod may contain 76 CPUs and 600 GB of memory.

FIG. 3 is a block diagram illustrating the control plane 204 in more detail and according to some examples. As mentioned, the data plane 206 is deployed by adding network proxies to each of the pods in the cluster 202. Each network proxy is uniquely associated with one of the pods and communications to and from that pod are effected via the network proxy. This includes communications to and from the control plane 204. Merely as an example, FIG. 3 illustrates lines of communication to and from network proxy 210a.

The control plane 204 may provide a set of services run in a dedicated namespace. These services, for example, execute actions like aggregating telemetry data, providing a user-facing API, and providing control data to the data plane 206. In FIG. 3, the control plane 204 comprises a controller 302 which provides a public API 304. The public API 304 can be accessed from a client device, e.g., via the web 308 or via a Command Line Interface (CLI 306), or another endpoint. The deployment of the controller 302 further includes the following containers: an identity component 310, a destination component 312, a tap component 314, a proxy injector 316 and an SP (service profile) validator 318.

The identity component 310 executes Certificate Authority (CA) functions. For example, the identity component 310 may accept requests from network proxies and return certificates signed with a correct identity. The destination component 312 may provide service discovery. The tap component 314 may be designed to receive and act on requests from the CLI 306 to watch requests and responses.

The proxy injector 316 is responsible for transforming a pod's specification to add the “sidecar” containing the relevant network proxy. The SP validator 318 is configured to validate new service profiles.

The control plane 204 may further provide access to observability components 320a and 320b. Observability component 320a may, for example, be a software application for event monitoring and alerting, such as Prometheus™. Prometheus™ can be used to expose data such as metrics from the service mesh. Observability component 320b may, for example, be a software application for analytics and visualization, such as Grafana™. Grafana™ provides actionable dashboards and metrics for the services running on the service mesh. One or more dashboards may be provided to allow a user to be presented with a real-time view of what is happening with the services in the cluster 202, e.g., for each of the pods containing a data loader, the user or client may check success rates, request data, latency, utilization, etc.

It should be appreciated that a service mesh may be deployed using other techniques or patterns than those disclosed herein. For example, a service mesh pattern is not limited to a particular environment or cluster architecture, or to a particular control plane, and it may be possible to create a service mesh regardless of whether applications or services are deployed using containers, virtual machines or other deployments, or whether the deployment is on premise, in the cloud, or a combination thereof.

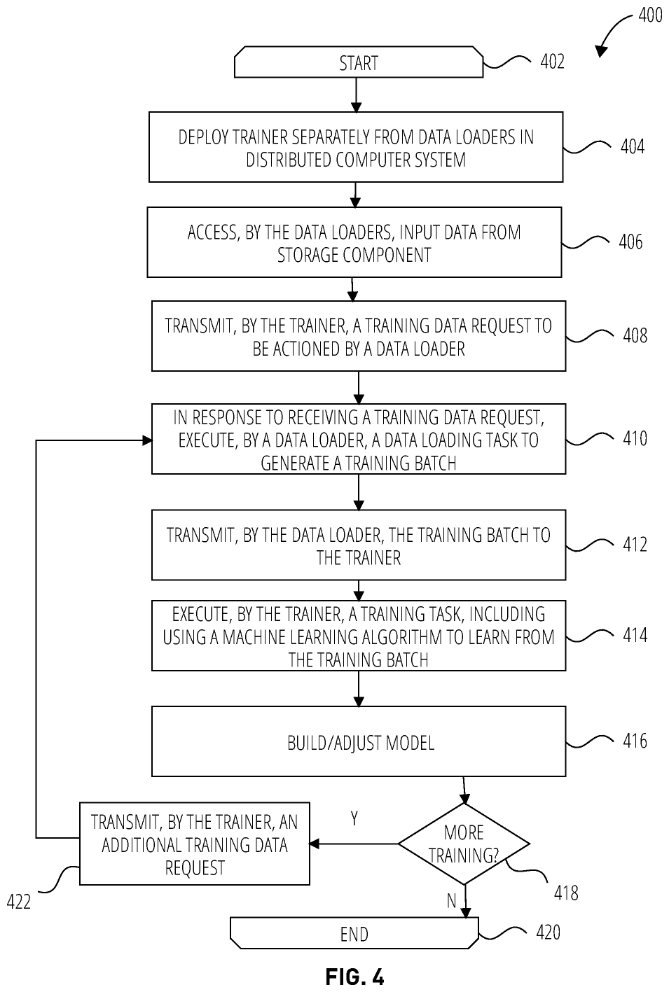

FIG. 4 illustrates a method 400 of distributed data loading and model training, according to some examples, described with reference to the distributed computer system 100 of FIG. 1.

The method 400 commences at opening loop block 402 and proceeds to block 404, where the trainer 102 is deployed separately from the data loaders 106a, 106b, 106c, in a distributed manner, as described above. Sufficient CPU resources in the distributed computer system 100 may be allocated or assigned to the data loaders 106a, 106b, 106c to enable them to carry out data loading at a desired rate or throughput. GPU resources may be allocated to the trainer 102, given that machine learning computations are, in some examples (e.g., when building visual element or visual object tracking models), GPU intensive. According to some examples of the present disclosure, the GPU resources are allocated such that each data loader does not utilize any of the GPU resources.

From block 404, the method 400 progresses to block 406, where the data loaders 106a, 106b, 106c access input data from the storage component 108. According to some examples, the method 400 may be used to build an object tracking model. Therefore, the input data may, for example, include one or more of hand detection data, hand tracking data, gesture detection data, and gesture tracking data.

Object tracking may involve landmark detection and the input data may thus include landmark data. For example, landmark detection using machine learning may involve identifying key points or features in an image or video frame that can be used to track the object as it moves. Examples of landmarks may include corners, edges, or other unique or identifiable features in the object. In some examples, a machine learning model is trained on a dataset of images or video frames that include an object of interest (and, in some examples, including annotations indicative of the relevant landmarks). Once the model has been trained, it can be used to detect the landmarks in new images or video frames, and track the object based on movement of the landmarks over time. This technique may be utilized in hand tracking as an example form of visual object tracking. In other words, machine learning models can be trained to detect and track a hand (or hands) based on hand landmarks. Accordingly, in some examples where a hand tracking model is built, the input data includes images of hands and annotations indicating locations of landmarks.

Returning to FIG. 4, the trainer 102 may, at block 408, transmit a training data request to be actioned by one of the data loaders. From block 408, the method 400 progresses to block 410, where, in response to receiving the training data request, the relevant data loader (e.g., the data loader 106a) executes a data loading task. The data loading task may include reading a batch of data from the input data, and preprocessing the batch of data to generate a training batch for transmission to the trainer 102. The data loading task may thus include a number of steps or sub-tasks, such as obtaining and preparing training data in a “raw” format, and transforming or augmenting the data as may be required. Preprocessing steps may include cropping and/or rotating an image, adding noise, or adjusting aspects such as brightness, contrast, saturation, hue, or the like, or combinations thereof.

The data loader may then, at block 412, transmit the training batch to the trainer 102. From block 412, the method 400 progresses to block 414, where the trainer 102 receives the training batch and uses a machine learning algorithm to learn from the training batch. This may be referred to as a training task. The trainer 102 uses what has been learnt or deduced from the training task to build or adjust parameters of the machine learning model, at block 416.

In some examples, the model building process is an iterative process, in which case it is desirable to feed the trainer 102 with batches of training data regularly until the building of the model is complete (e.g., until a satisfactory number of iterations of the training task have been completed or until the model performs satisfactorily). It will be appreciated that it may be desirable to feed as many different training batches as possible to the trainer 102. In some examples, the same training batch can be repeatedly used by a trainer.

Accordingly, if more training is required (see decision block 418), the trainer 102 transmits an additional training data request at block 422. Blocks 410, 412, 414 and 416 may then be repeated, but it will be appreciated that a different data loader (e.g., the data loader 106b) may receive the additional training data request and generate a new training batch for the trainer 212 to learn from. The process may continue until no further training is required or desired (see decision block 418 again), in which case the method 400 concludes at closing loop block 420.

A model may be run against an entire training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset (training batches) are used to train the model. Thus, the batch size ranges between 1 and the size of the training dataset while the number of epochs is any positive integer value. The model parameters may be updated after each batch.

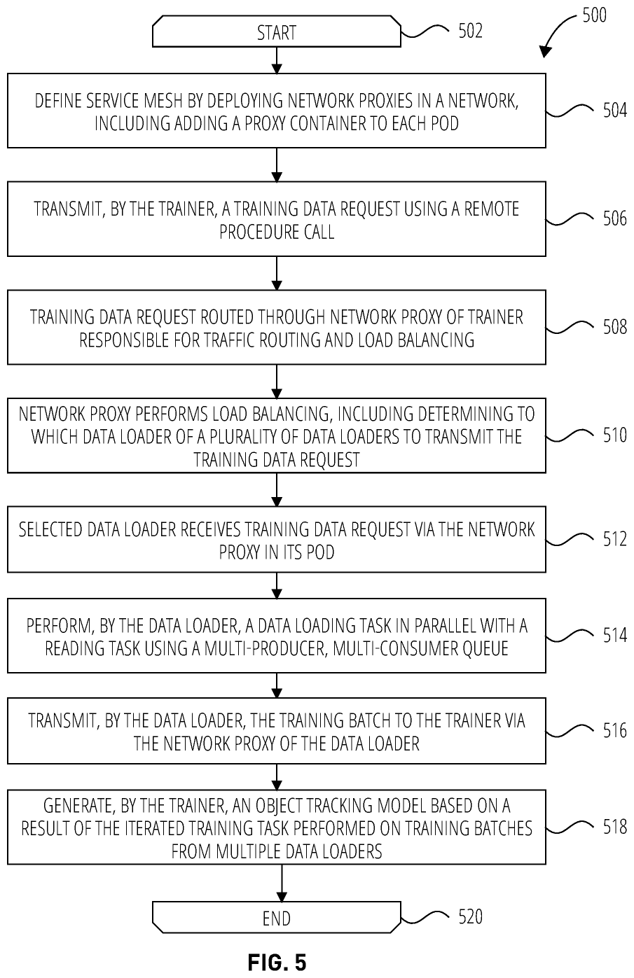

FIG. 5 illustrates a method 500 of distributed data loading and model training across a service mesh to generate an object tracking model, according to some examples, described with reference to the distributed computer system 200 of FIG. 2.

The method 500 commences at opening loop block 502 and proceeds to block 504, where a service mesh is defined by deploying network proxies as described with reference to FIG. 2. For example, and referring to the cluster 202 of FIG. 2, a dedicated network proxy 210a, 210b, 210c, 210d, 210e in the form of a proxy container may be added, e.g., injected, into each pod 208a, 208b, 208c, 208d, 208e in the cluster 202 to define a service mesh data plane 206. The control plane 204 is communicatively coupled to the data plane 206 and may include the elements described with reference to FIG. 3.

From block 504, the method 500 proceeds to block 506, where the trainer 212 transmits a training data request using a Remote Procedure Call, e.g., gRPC. The calls sent from the trainer 212 may be service-to-service calls. Given the service mesh architecture deployed in the distributed computer system 200, the training data request is routed via the network proxy 210a and, at block 508, the network proxy 210a attends to traffic routing and load balancing so as to optimize the utilization of the trainer 212.

In some examples, a Remote Procedure Call, such as gRPC, is used by the trainer 212 (via the network proxies) to call other processes in the distributed computer system 200, e.g., to request that a data loader perform a data loading task and feed the trainer 212 with a training batch. The trainer 212 may thus be regarded as a client while the data loader acting in response to the call may be regarded as a server.

The network proxies may be configured to auto-detect HTTP/2 and do load balancing. The network proxies may watch the control plane 204 and automatically update a load balancing pool based on the performance or rescheduling of the pods 208b, 208c, 208d, 208e. When using a service mesh platform such as Linkerd™, pods may be configured to proxy Transmission Control Protocol (TCP) traffic, but automatically detect the layer-7 protocol used. Application code making any TCP connection has that connection proxied through its local Linkerd™ instance, and if the connection uses gRPC, the service mesh automatically alters its behavior to layer-7 semantics—e.g., by reporting success rates, retrying idempotent requests, load balancing at the request level, etc.

Returning to FIG. 5, and block 510 in particular, the service mesh is used to determine which data loader in the distributed computer system 200 the specific training data request should be sent to. For example, the network proxy 210a in the service mesh may use an exponentially-weighted moving average of response latencies to determine which one of the four data loading pods (208b, 208c, 208d, 208e) to send the specific training data request to at a given point in time. In other words, the training data request may, in each case, be transmitted to the pod determined to be the “fastest.” If the service mesh determines that one pod is slowing down or unavailable, traffic may be shifted away from it to reduce latencies and improve efficiency.

The distributed computer system 200 may, in some examples, monitor the efficiency of its components, e.g., the utilization level of the trainer 212, and initiate certain actions to improve efficiency and/or throughput. For example, if it is determined that the data loading pods (208b, 208c, 208d, 208e) are resulting in a bottleneck, one or more additional data loading pods may automatically be deployed to serve the trainer 212 and increase its utilization. The one or more additional data loading pods may be replicas of the original pods. Alternatively, if it is, for example, determined that the trainer 212 is saturated (e.g., utilizing all available GPU resources), one or more additional trainer may automatically be deployed. If multiple trainers are deployed, they may each be served by all available data loaders or a sub-set of the data loaders may be allocated to each trainer, depending on the implementation.

From block 510, the method 500 proceeds to block 512, where the selected data loader (e.g., the data loader 214a) receives the training data request. The training data request is routed via the network proxy in its pod (e.g., the network proxy 210b in pod 208b). The data loader then performs a data loading task as described above. According to some examples, the method 500 includes performing, by the data loader handling the training data request, the data loading task in parallel (or partially in parallel) with a reading task using a queue process (see block 514).

A queue may be created by the relevant data loader to cache read input data so that incoming training data requests can be served from the queue. For example, the data loaders 214a, 214b, 214c, 214d in the distributed computer system 200 may each implement a multi-producer, multi-consumer queue. This may allow the data loader to run two processes: a reading task, which reads or fetches input batches from the storage component and adds the input batches to a queue, and the loading task which is used to preprocess (e.g., transform and augment) the input batches as required. Such a queue process may improve the efficiency of a data loader, as each new input batch can simply be preprocessed from a preprocessing queue without having to wait for the new input batch to be read from storage. A queue process may, at least to some extent, decouple data loading and data serving.

At block 516, once the data loader (e.g., the data loader 214a) has completed the data loading task to generate a training batch, the training batch is transmitted to the trainer 212 via the network proxies in the service mesh.

As described above, the trainer 212 may iteratively perform training tasks using different training batches received from the data loaders 214a, 214b, 214c, 214d to generate a machine learning model. In FIG. 5, the machine learning model is an object tracking model. The trainer 212 may, in some examples, receive a large number of training batches from each of the data loaders to permit the training task to be iterated, thereby to build and refine the object tracking model's parameters. The training batches may include images of hands with annotations reflecting landmark points or landmark data.

It should be appreciated that the actions described with reference to blocks 506, 508, 510, 512, 514 and/or 516 may be repeated multiple times, using different data loaders, e.g., in each case based on exponentially-weighted moving average of response latencies, to generate a final or near-final version of the object tracking model at block 518, and thereafter the method 500 may conclude at closing loop block 520.

Referring to both FIG. 4 and FIG. 5, although the example flow charts each depict a particular sequence of operations, a sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

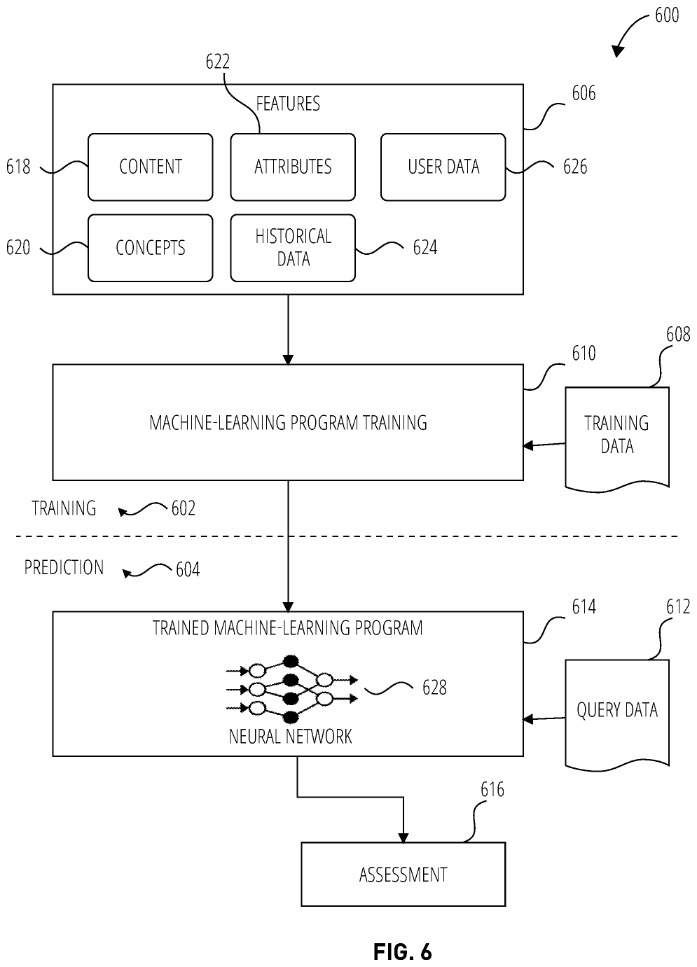

FIG. 6 is a block diagram showing a machine-learning program 600, according to some examples. Machine-learning programs 600, also referred to as machine-learning algorithms or machine-learning tools, may be used to perform operations associated with, for example, object tracking, hand detection, landmark detection, gesture recognition, or landmark recognition. For example, machine-learning algorithms may be used as part of the systems described herein, e.g., in the trainer 102 and/or the trainer 212.

Machine-learning tools may operate by building a model from example training data 608 in order to make data-driven predictions or decisions expressed as outputs or assessments (e.g., assessment 616). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 600 supports two types of phases, namely a training phase 602 and prediction phase 604. In training phases 602, supervised learning, unsupervised or reinforcement learning may be used. For example, the machine-learning program 600 (1) receives features 606 (e.g., as structured or labeled data in supervised learning) and/or (2) identifies features 606 (e.g., unstructured or unlabeled data for unsupervised learning) in training data 608. In prediction phases 604, the machine-learning program 600 uses the features 606 for analyzing query data 612 to generate outcomes or predictions, as examples of an assessment 616.

In the training phase 602, feature engineering is used to identify features 606 and may include identifying informative, discriminating, and independent features for the effective operation of the machine-learning program 600 in pattern recognition, classification, and regression. In some examples, the training data 608 includes labeled data, which is known data for pre-identified features 606 and one or more outcomes. Each of the features 606 may be a variable or attribute, such as individual measurable property of a process, article, system, or phenomenon represented by a dataset (e.g., the training data 608). Features 606 may also be of different types, such as numeric features, strings, and graphs, and may include one or more of content 618, concepts 620, attributes 622, historical data 624 and/or user data 626, merely for example.

In training phases 602, the machine-learning program 600 uses the training data 608 to find correlations among the features 606 that affect a predicted outcome or assessment 616.

With the training data 608 and the identified features 606, the machine-learning program 600 is trained during the training phase 602 at machine-learning program training 610. The machine-learning program 600 appraises values of the features 606 as they correlate to the training data 608. The result of the training is the trained machine-learning program 614 (e.g., a trained or learned model).

Further, the training phases 602 may involve machine learning, in which the training data 608 is structured (e.g., labeled during preprocessing operations), and the trained machine-learning program 614 implements a relatively simple neural network 628 capable of performing, for example, classification and clustering operations. In other examples, the training phase 602 may involve deep learning, in which the training data 608 is unstructured, and the trained machine-learning program 614 implements a deep neural network 628 that is able to perform both feature extraction and classification/clustering operations.

A neural network 628 generated during the training phase 602, and implemented within the trained machine-learning program 614, may include a hierarchical (e.g., layered) organization of neurons. For example, neurons (or nodes) may be arranged hierarchically into a number of layers, including an input layer, an output layer, and multiple hidden layers. Each of the layers within the neural network 628 can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network 628 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 604, the trained machine-learning program 614, also referred to as the machine-learning model, is used to perform an assessment. Query data 612 is provided as an input to the trained machine-learning program 614, and the trained machine-learning program 614 generates the assessment 616 as output, responsive to receipt of the query data 612.

### Networked Computing Environment

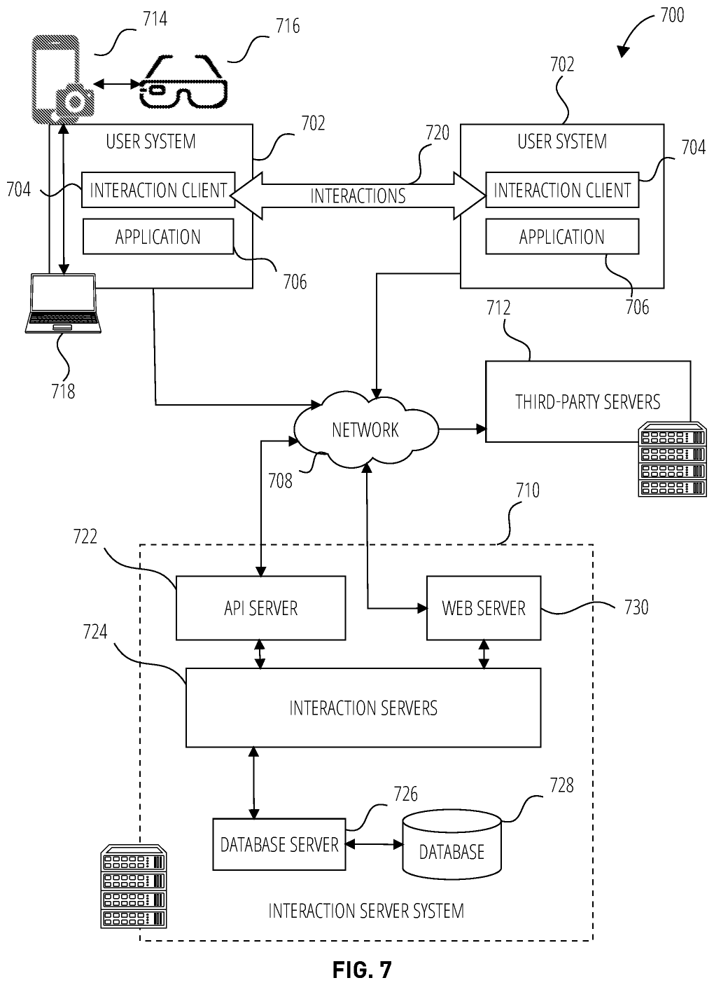

FIG. 7 is a block diagram showing an example interaction system 700 for facilitating interactions (e.g., exchanging text messages, conducting text audio and video calls, or playing games) over a network. The interaction system 700 includes multiple user systems 702 each of which hosts multiple applications, including an interaction client 704 and other applications 706. Each interaction client 704 is communicatively coupled, via one or more communication networks including a network 708 (e.g., the Internet), to other instances of the interaction client 704 (e.g., hosted on respective other user systems 702), an interaction server system 710 and third-party servers 712). An interaction client 704 can also communicate with locally hosted applications 706 using Applications Program Interfaces (APIs).

Each user system 702 may include multiple user devices, such as a mobile device 714, head-wearable apparatus 716, and a computer client device 718 that are communicatively connected to exchange data and messages.

An interaction client 704 interacts with other interaction clients 704 and with the interaction server system 710 via the network 708. The data exchanged between the interaction clients 704 (e.g., interactions 720) and between the interaction clients 704 and the interaction server system 710 includes functions (e.g., commands to invoke functions) and payload data (e.g., text, audio, video, or other multimedia data).

The interaction server system 710 provides server-side functionality via the network 708 to the interaction clients 704. While certain functions of the interaction system 700 are described herein as being performed by either an interaction client 704 or by the interaction server system 710, the location of certain functionality either within the interaction client 704 or the interaction server system 710 may be a design choice. For example, it may be technically preferable to initially deploy particular technology and functionality within the interaction server system 710 but to later migrate this technology and functionality to the interaction client 704 where a user system 702 has sufficient processing capacity.

The interaction server system 710 supports various services and operations that are provided to the interaction clients 704. Such operations include transmitting data to, receiving data from, and processing data generated by the interaction clients 704. This data may include message content, client device information, geolocation information, media augmentation and overlays, message content persistence conditions, social network information, and live event information. Data exchanges within the interaction system 700 are invoked and controlled through functions available via user interfaces (UIs) of the interaction clients 704.

Turning now specifically to the interaction server system 710, an Application Program Interface (API) server 722 is coupled to and provides programmatic interfaces to interaction servers 724, making the functions of the interaction servers 724 accessible to interaction clients 704, other applications 706 and third-party server 712. The interaction servers 724 are communicatively coupled to a database server 726, facilitating access to a database 728 that stores data associated with interactions processed by the interaction servers 724. Similarly, a web server 730 is coupled to the interaction servers 724 and provides web-based interfaces to the interaction servers 724. To this end, the web server 730 processes incoming network requests over the Hypertext Transfer Protocol (HTTP) and several other related protocols.

The Application Program Interface (API) server 722 receives and transmits interaction data (e.g., commands and message payloads) between the interaction servers 724 and the user systems 702 (and, for example, interaction clients 704 and other application 706) and the third-party server 712. Specifically, the Application Program Interface (API) server 722 provides a set of interfaces (e.g., routines and protocols) that can be called or queried by the interaction client 704 and other applications 706 to invoke functionality of the interaction servers 724. The Application Program Interface (API) server 722 exposes various functions supported by the interaction servers 724, including account registration; login functionality; the sending of interaction data, via the interaction servers 724, from a particular interaction client 704 to another interaction client 704; the communication of media files (e.g., images or video) from an interaction client 704 to the interaction servers 724; the settings of a collection of media data (e.g., a story); the retrieval of a list of friends of a user of a user system 702; the retrieval of messages and content; the addition and deletion of entities (e.g., friends) to an entity graph (e.g., a social graph); the location of friends within a social graph; and opening an application event (e.g., relating to the interaction client 704).

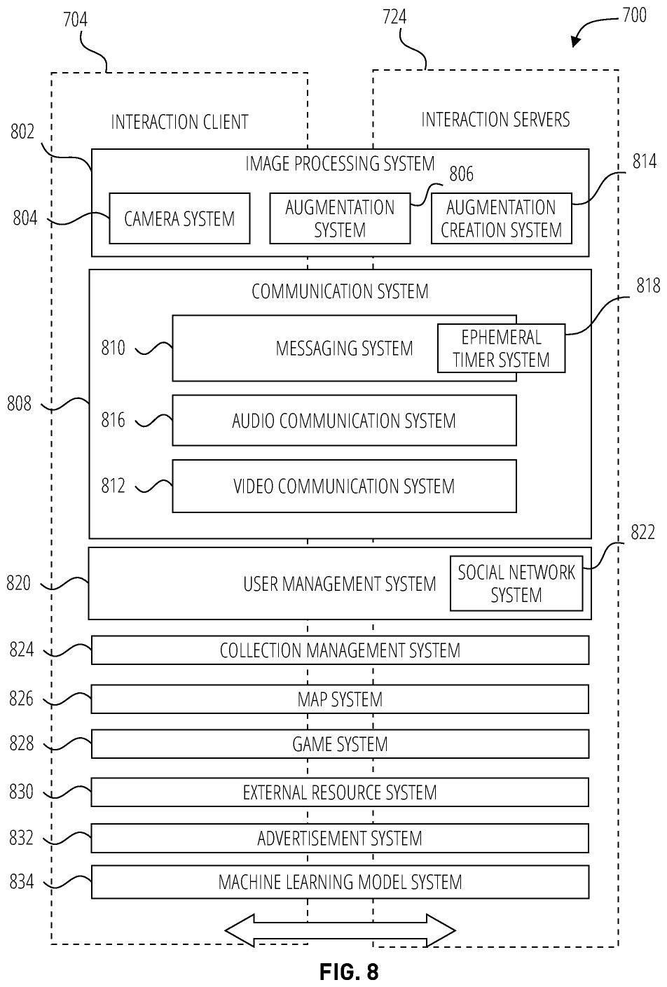

The interaction servers 724 host multiple systems and subsystems, described below with reference to FIG. 8.

### System Architecture

FIG. 8 is a block diagram illustrating further details regarding the interaction system 700, according to some examples. Specifically, the interaction system 700 is shown to comprise the interaction client 704 and the interaction servers 724. The interaction system 700 embodies multiple subsystems, which are supported on the client-side by the interaction client 704 and on the server-side by the interaction servers 724. Example subsystems are discussed below.

An image processing system 802 provides various functions that enable a user to capture and augment (e.g., annotate or otherwise modify or edit) media content associated with a message.

A camera system 804 includes control software (e.g., in a camera application) that interacts with and controls hardware camera hardware (e.g., directly or via operating system controls) of the user system 702 to modify and augment real-time images captured and displayed via the interaction client 704.

The augmentation system 806 provides functions related to the generation and publishing of augmentations (e.g., media overlays) for images captured in real-time by cameras of the user system 702 or retrieved from memory of the user system 702. For example, the augmentation system 806 operatively selects, presents, and displays media overlays (e.g., an image filter or an image lens) to the interaction client 704 for the augmentation of real-time images received via the camera system 804 or stored images retrieved from memory 1102 of a user system 702. These augmentations are selected by the augmentation system 806 and presented to a user of an interaction client 704, based on a number of inputs and data, such as for example:
Geolocation of the user system 702; and
Social network information of the user of the user system 702.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 702 for communication in a message, or applied to video content, such as a video content stream or feed transmitted from an interaction client 704. As such, the image processing system 802 may interact with, and support, the various subsystems of the communication system 808, such as the messaging system 810 and the video communication system 812.

A media overlay may include text or image data that can be overlaid on top of a photograph taken by the user system 702 or a video stream produced by the user system 702. In some examples, the media overlay may be a location overlay (e.g., Venice beach), a name of a live event, or a name of a merchant overlay (e.g., Beach Coffee House). In further examples, the image processing system 802 uses the geolocation of the user system 702 to identify a media overlay that includes the name of a merchant at the geolocation of the user system 702. The media overlay may include other indicia associated with the merchant. The media overlays may be stored in the databases 728 and accessed through the database server 726.

The image processing system 802 provides a user-based publication platform that enables users to select a geolocation on a map and upload content associated with the selected geolocation. The user may also specify circumstances under which a particular media overlay should be offered to other users. The image processing system 802 generates a media overlay that includes the uploaded content and associates the uploaded content with the selected geolocation.

The augmentation creation system 814 supports augmented reality developer platforms and includes an application for content creators (e.g., artists and developers) to create and publish augmentations (e.g., augmented reality experiences) of the interaction client 704. The augmentation creation system 814 provides a library of built-in features and tools to content creators including, for example custom shaders, tracking technology, and templates.

In some examples, the augmentation creation system 814 provides a merchant-based publication platform that enables merchants to select a particular augmentation associated with a geolocation via a bidding process. For example, the augmentation creation system 814 associates a media overlay of the highest bidding merchant with a corresponding geolocation for a predefined amount of time.

A communication system 808 is responsible for enabling and processing multiple forms of communication and interaction within the interaction system 700 and includes a messaging system 810, an audio communication system 816, and a video communication system 812. The messaging system 810 is responsible for enforcing the temporary or time-limited access to content by the interaction clients 704. The messaging system 810 incorporates multiple timers (e.g., within an ephemeral timer system 818) that, based on duration and display parameters associated with a message or collection of messages (e.g., a story), selectively enable access (e.g., for presentation and display) to messages and associated content via the interaction client 704. Further details regarding the operation of the ephemeral timer system 818 are provided below. The audio communication system 816 enables and supports audio communications (e.g., real-time audio chat) between multiple interaction clients 704. Similarly, the video communication system 812 enables and supports video communications (e.g., real-time video chat) between multiple interaction clients 704.

A user management system 820 is operationally responsible for the management of user data and profiles, and includes a social network system 822 that maintains information regarding relationships between users of the interaction system 700.

A collection management system 824 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 824 may also be responsible for publishing an icon that provides notification of a particular collection to the user interface of the interaction client 704. The collection management system 824 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 824 employs machine vision (or image recognition technology) and content rules to curate a content collection automatically. In certain examples, compensation may be paid to a user to include user-generated content into a collection. In such cases, the collection management system 824 operates to automatically make payments to such users to use their content.

A map system 826 provides various geographic location functions and supports the presentation of map-based media content and messages by the interaction client 704. For example, the map system 826 enables the display of user icons or avatars (e.g., stored in profile data 902) on a map to indicate a current or past location of “friends” of a user, as well as media content (e.g., collections of messages including photographs and videos) generated by such friends, within the context of a map. For example, a message posted by a user to the interaction system 700 from a specific geographic location may be displayed within the context of a map at that particular location to “friends” of a specific user on a map interface of the interaction client 704. A user can furthermore share his or her location and status information (e.g., using an appropriate status avatar) with other users of the interaction system 700 via the interaction client 704, with this location and status information being similarly displayed within the context of a map interface of the interaction client 704 to selected users.

A game system 828 provides various gaming functions within the context of the interaction client 704. The interaction client 704 provides a game interface providing a list of available games that can be launched by a user within the context of the interaction client 704 and played with other users of the interaction system 700. The interaction system 700 further enables a particular user to invite other users to participate in the play of a specific game by issuing invitations to such other users from the interaction client 704. The interaction client 704 also supports audio, video, and text messaging (e.g., chats) within the context of gameplay, provides a leaderboard for the games, and also supports the provision of in-game rewards (e.g., coins and items).

An external resource system 830 provides an interface for the interaction client 704 to communicate with remote servers (e.g., third-party servers 712) to launch or access external resources, i.e., applications or applets. Each third-party server 712 hosts, for example, a markup language (e.g., HTML5) based application or a small-scale version of an application (e.g., game, utility, payment, or ride-sharing application). The interaction client 704 may launch a web-based resource (e.g., application) by accessing the HTML5 file from the third-party servers 712 associated with the web-based resource. Applications hosted by third-party servers 712 are programmed in JavaScript leveraging a Software Development Kit (SDK) provided by the interaction servers 724. The SDK includes Application Programming Interfaces (APIs) with functions that can be called or invoked by the web-based application. The interaction servers 724 host a JavaScript library that provides a given external resource access to specific user data of the interaction client 704. HTML5 is an example of technology for programming games, but applications and resources programmed based on other technologies can be used.

To integrate the functions of the SDK into the web-based resource, the SDK is downloaded by the third-party server 712 from the interaction servers 724 or is otherwise received by the third-party server 712. Once downloaded or received, the SDK is included as part of the application code of a web-based external resource. The code of the web-based resource can then call or invoke certain functions of the SDK to integrate features of the interaction client 704 into the web-based resource.

The SDK stored on the interaction server system 710 effectively provides the bridge between an external resource (e.g., applications 706 or applets) and the interaction client 704. This gives the user a seamless experience of communicating with other users on the interaction client 704 while also preserving the look and feel of the interaction client 704. To bridge communications between an external resource and an interaction client 704, the SDK facilitates communication between third-party servers 712 and the interaction client 704. A Web ViewJavaScriptBridge running on a user system 702 establishes two one-way communication channels between an external resource and the interaction client 704. Messages are sent between the external resource and the interaction client 704 via these communication channels asynchronously. Each SDK function invocation is sent as a message and callback. Each SDK function is implemented by constructing a unique callback identifier and sending a message with that callback identifier.

By using the SDK, not all information from the interaction client 704 is shared with third-party servers 712. The SDK limits which information is shared based on the needs of the external resource. Each third-party server 712 provides an HTML5 file corresponding to the web-based external resource to interaction servers 724. The interaction servers 724 can add a visual representation (such as a box art or other graphic) of the web-based external resource in the interaction client 704. Once the user selects the visual representation or instructs the interaction client 704 through a GUI of the interaction client 704 to access features of the web-based external resource, the interaction client 704 obtains the HTML5 file and instantiates the resources to access the features of the web-based external resource.

The interaction client 704 presents a graphical user interface (e.g., a landing page or title screen) for an external resource. During, before, or after presenting the landing page or title screen, the interaction client 704 determines whether the launched external resource has been previously authorized to access user data of the interaction client 704. In response to determining that the launched external resource has been previously authorized to access user data of the interaction client 704, the interaction client 704 presents another graphical user interface of the external resource that includes functions and features of the external resource. In response to determining that the launched external resource has not been previously authorized to access user data of the interaction client 704, after a threshold period of time (e.g., 3 seconds) of displaying the landing page or title screen of the external resource, the interaction client 704 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 704 adds the external resource to a list of authorized external resources and allows the external resource to access user data from the interaction client 704. The external resource is authorized by the interaction client 704 to access the user data under an OAuth 2 framework.

The interaction client 704 controls the type of user data that is shared with external resources based on the type of external resource being authorized. For example, external resources that include full-scale applications (e.g., an application 706) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 832 operationally enables the purchasing of advertisements by third parties for presentation to end-users via the interaction clients 704 and also handles the delivery and presentation of these advertisements.

A machine learning model system 834 may perform functions relating to training and implementation of machine learning models, e.g., for gesture recognition, hand tracking, object detection, and related functions. The machine learning model system 834 may include or be communicatively coupled to a distributed computer system for data loading and model training, e.g., a system as depicted in FIG. 1 or FIG. 2. Machine learning models built using such a distributed computer system may be deployed on the client-side by the interaction client 704 or on the server-side by the interaction servers 724, or on both sides.

### Data Architecture

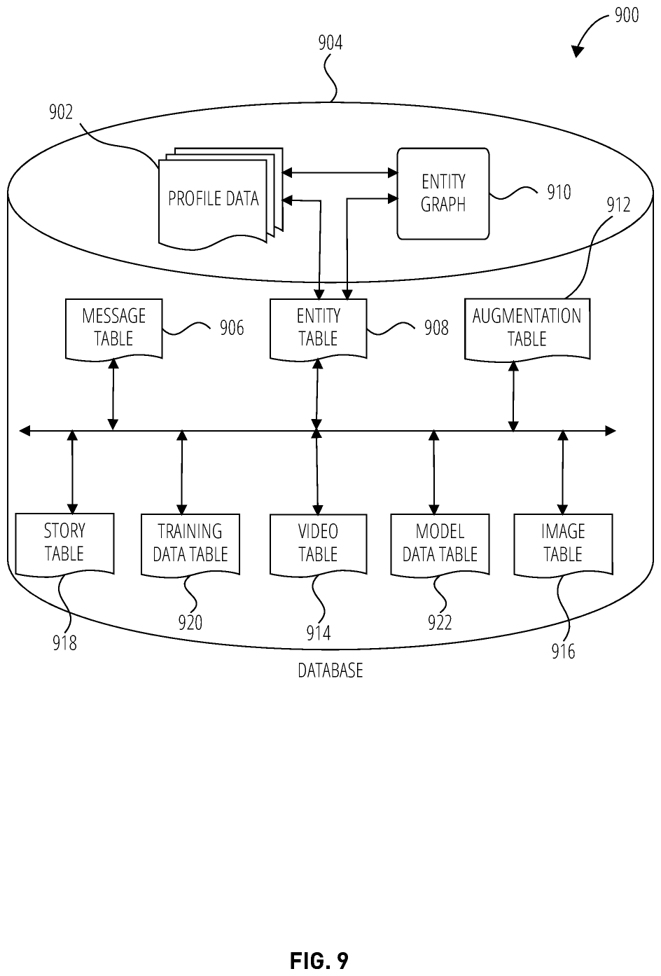

FIG. 9 is a schematic diagram illustrating data structures 900, which may be stored in the database 904 of the interaction server system 710, according to certain examples. While the content of the database 904 is shown to comprise multiple tables, it will be appreciated that the data could be stored in other types of data structures (e.g., as an object-oriented database).

The database 904 includes message data stored within a message table 906. This message data includes, for any particular message, at least message sender data, message recipient (or receiver) data, and a payload. Further details regarding information that may be included in a message, and included within the message data stored in the message table 906, are described below with reference to FIG. 9.

An entity table 908 stores entity data, and is linked (e.g., referentially) to an entity graph 910 and profile data 902. Entities for which records are maintained within the entity table 908 may include individuals, corporate entities, organizations, objects, places, events, and so forth. Regardless of entity type, any entity regarding which the interaction server system 710 stores data may be a recognized entity. Each entity is provided with a unique identifier, as well as an entity type identifier (not shown).

The entity graph 910 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 700.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 908. Such privacy settings may be applied to all types of relationships within the context of the interaction system 700, or may selectively be applied to certain types of relationships.

The profile data 902 stores multiple types of profile data about a particular entity. The profile data 902 may be selectively used and presented to other users of the interaction system 700 based on privacy settings specified by a particular entity. Where the entity is an individual, the profile data 902 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 700, and on map interfaces displayed by interaction clients 704 to other users. The collection of avatar representations may include “status avatars,” which present a graphical representation of a status or activity that the user may select to communicate at a particular time.

Where the entity is a group, the profile data 902 for the group may similarly include one or more avatar representations associated with the group, in addition to the group name, members, and various settings (e.g., notifications) for the relevant group.

The database 904 also stores augmentation data, such as overlays or filters, in an augmentation table 912. The augmentation data is associated with and applied to videos (for which data is stored in a video table 914) and images (for which data is stored in an image table 916).

Filters, in some examples, are overlays that are displayed as overlaid on an image or video during presentation to a recipient user. Filters may be of various types, including user-selected filters from a set of filters presented to a sending user by the interaction client 704 when the sending user is composing a message. Other types of filters include geolocation filters (also known as geo-filters), which may be presented to a sending user based on geographic location. For example, geolocation filters specific to a neighborhood or special location may be presented within a user interface by the interaction client 704, based on geolocation information determined by a Global Positioning System (GPS) unit of the user system 702.

Another type of filter is a data filter, which may be selectively presented to a sending user by the interaction client 704 based on other inputs or information gathered by the user system 702 during the message creation process. Examples of data filters include current temperature at a specific location, a current speed at which a sending user is traveling, battery life for a user system 702, or the current time.

Other augmentation data that may be stored within the image table 916 includes augmented reality content items (e.g., corresponding to applying “lenses” or augmented reality experiences). An augmented reality content item may be a real-time special effect and sound that may be added to an image or a video.

A story table 918 stores data regarding collections of messages and associated image, video, or audio data, which are compiled into a collection (e.g., a story or a gallery). The creation of a particular collection may be initiated by a particular user (e.g., each user for which a record is maintained in the entity table 908). A user may create a “personal story” in the form of a collection of content that has been created and sent/broadcast by that user. To this end, the user interface of the interaction client 704 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 704, to contribute content to a particular live story. The live story may be identified to the user by the interaction client 704, based on his or her location. The end result is a “live story” told from a community perspective.

A further type of content collection is known as a “location story,” which enables a user whose user system 702 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 914 stores video data that, in some examples, is associated with messages for which records are maintained within the message table 906. Similarly, the image table 916 stores image data associated with messages for which message data is stored in the entity table 908. The entity table 908 may associate various augmentations from the augmentation table 912 with various images and videos stored in the image table 916 and the video table 914.

The database 904 also includes a training data table 920 and a model data table 922. The training data table 920 may store input data used by data loaders for preprocessing into training batches, according to some examples. The training data table 920 may also store training batches, according to some examples. The model data table 922 may store data related to machine learning models, such as object tracking models, according to some examples.

### Data Communications Architecture

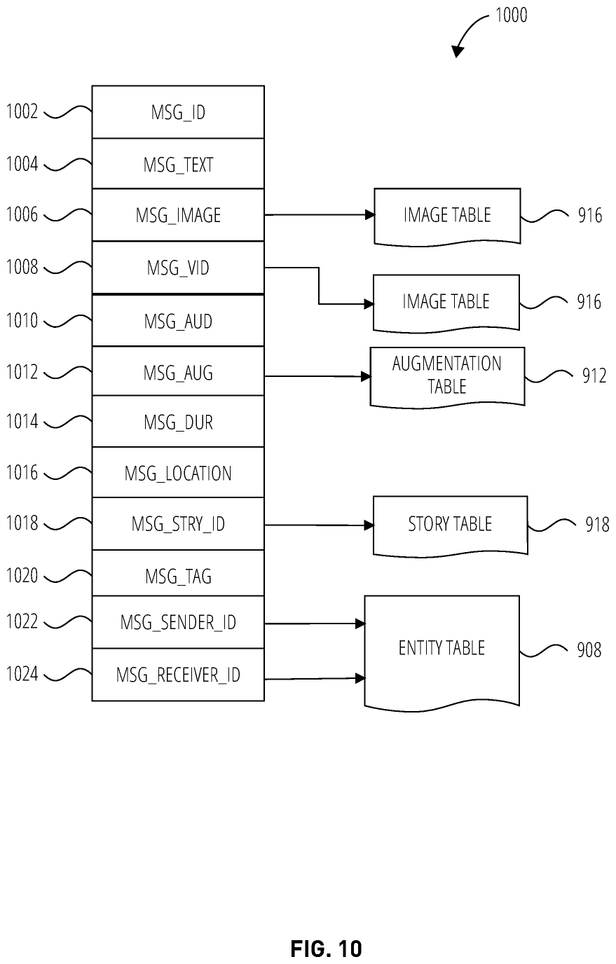

FIG. 10 is a schematic diagram illustrating a structure of a message 1000, according to some examples, generated by an interaction client 704 for communication to a further interaction client 704 via the interaction servers 724. The content of a particular message 1000 is used to populate the message table 906 stored within the database 904, accessible by the interaction servers 724. Similarly, the content of a message 1000 is stored in memory as “in-transit” or “in-flight” data of the user system 702 or the interaction servers 724. A message 1000 is shown to include the following example components:
Message identifier 1002: a unique identifier that identifies the message 1000.
Message text payload 1004: text, to be generated by a user via a user interface of the user system 702, and that is included in the message 1000.
Message image payload 1006: image data, captured by a camera component of a user system 702 or retrieved from a memory component of a user system 702, and that is included in the message 1000. Image data for a sent or received message 1000 may be stored in the image table 916.
Message video payload 1008: video data, captured by a camera component or retrieved from a memory component of the user system 702, and that is included in the message 1000. Video data for a sent or received message 1000 may be stored in the image table 916.
Message audio payload 1010: audio data, captured by a microphone or retrieved from a memory component of the user system 702, and that is included in the message 1000.
Message augmentation data 1012: augmentation data (e.g., filters, stickers, or other annotations or enhancements) that represents augmentations to be applied to message image payload 1006, message video payload 1008, or message audio payload 1010 of the message 1000. Augmentation data for a sent or received message 1000 may be stored in the augmentation table 912.
Message duration parameter 1014: parameter value indicating, in seconds, the amount of time for which content of the message (e.g., the message image payload 1006, message video payload 1008, message audio payload 1010) is to be presented or made accessible to a user via the interaction client 704.
Message geolocation parameter 1016: geolocation data (e.g., latitudinal and longitudinal coordinates) associated with the content payload of the message. Multiple message geolocation parameter 1016 values may be included in the payload, each of these parameter values being associated with respect to content items included in the content (e.g., a specific image within the message image payload 1006, or a specific video in the message video payload 1008).
Message story identifier 1018: identifier values identifying one or more content collections (e.g., “stories” identified in the story table 918) with which a particular content item in the message image payload 1006 of the message 1000 is associated. For example, multiple images within the message image payload 1006 may each be associated with multiple content collections using identifier values.
Message tag 1020: each message 1000 may be tagged with multiple tags, each of which is indicative of the subject matter of content included in the message payload. For example, where a particular image included in the message image payload 1006 depicts an animal (e.g., a lion), a tag value may be included within the message tag 1020 that is indicative of the relevant animal. Tag values may be generated manually, based on user input, or may be automatically generated using, for example, image recognition.
Message sender identifier 1022: an identifier (e.g., a messaging system identifier, email address, or device identifier) indicative of a user of the user system 702 on which the message 1000 was generated and from which the message 1000 was sent.
Message receiver identifier 1024: an identifier (e.g., a messaging system identifier, email address, or device identifier) indicative of a user of the user system 702 to which the message 1000 is addressed.

The contents (e.g., values) of the various components of message 1000 may be pointers to locations in tables within which content data values are stored. For example, an image value in the message image payload 1006 may be a pointer to (or address of) a location within an image table 916. Similarly, values within the message video payload 1008 may point to data stored within an image table 916, values stored within the message augmentation data 1012 may point to data stored in an augmentation table 912, values stored within the message story identifier 1018 may point to data stored in a story table 918, and values stored within the message sender identifier 1022 and the message receiver identifier 1024 may point to user records stored within an entity table 908.

System with Head-Wearable Apparatus

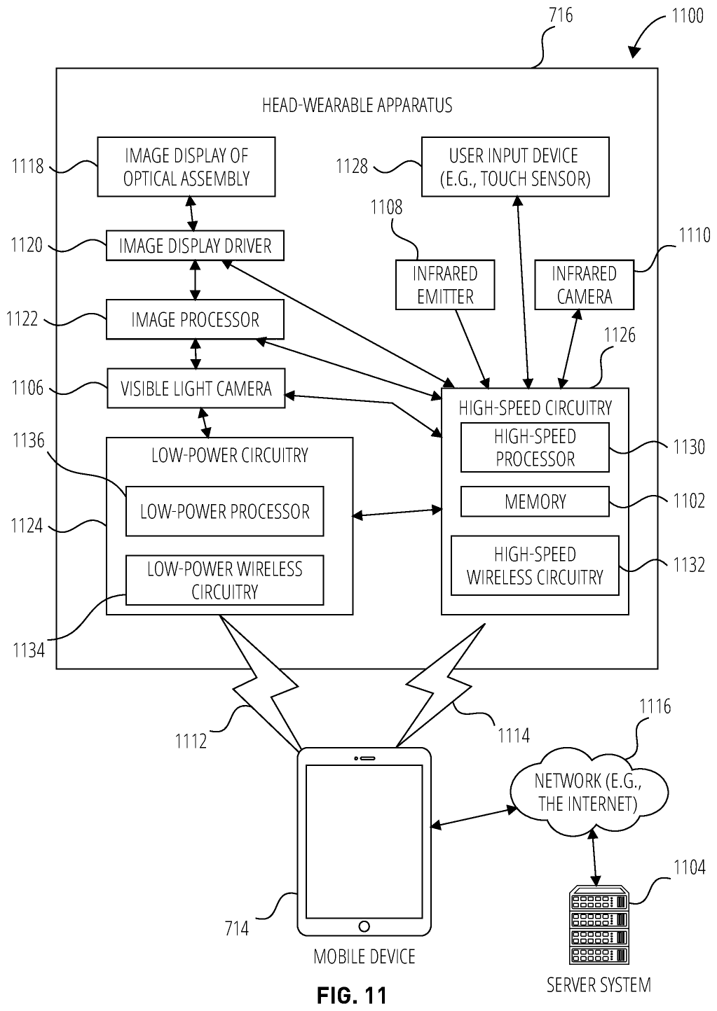

FIG. 11 illustrates a system 1100 including a head-wearable apparatus 716 with a selector input device, according to some examples. FIG. 11 is a high-level functional block diagram of an example head-wearable apparatus 716 communicatively coupled to a mobile device 714 and various server systems 1104 (e.g., the interaction server system 710) via various networks 708.

The head-wearable apparatus 716 includes one or more cameras, each of which may be, for example, a visible light camera 1106, an infrared emitter 1108, and an infrared camera 1110.

The mobile device 714 connects with head-wearable apparatus 716 using both a low-power wireless connection 1112 and a high-speed wireless connection 1114. The mobile device 714 is also connected to the server system 1104 and the network 1116.

The head-wearable apparatus 716 further includes two image displays of the image display of optical assembly 1118. The two image displays of optical assembly 1118 include one associated with the left lateral side and one associated with the right lateral side of the head-wearable apparatus 716. The head-wearable apparatus 716 also includes an image display driver 1120, an image processor 1122, low-power circuitry 1124, and high-speed circuitry 1126. The image display of optical assembly 1118 is for presenting images and videos, including an image that can include a graphical user interface to a user of the head-wearable apparatus 716.

The image display driver 1120 commands and controls the image display of optical assembly 1118. The image display driver 1120 may deliver image data directly to the image display of optical assembly 1118 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 716 includes a frame and stems (or temples) extending from a lateral side of the frame. The head-wearable apparatus 716 further includes a user input device 1128 (e.g., touch sensor or push button), including an input surface on the head-wearable apparatus 716. The user input device 1128 (e.g., touch sensor or push button) is to receive from the user an input selection to manipulate the graphical user interface of the presented image.

The components shown in FIG. 11 for the head-wearable apparatus 716 are located on one or more circuit boards, for example a PCB or flexible PCB, in the rims or temples. Alternatively, or additionally, the depicted components can be located in the chunks, frames, hinges, or bridge of the head-wearable apparatus 716. Left and right visible light cameras 1106 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 716 includes a memory 1102, which stores instructions to perform a subset or all of the functions described herein. The memory 1102 can also include storage device.

As shown in FIG. 11, the high-speed circuitry 1126 includes a high-speed processor 1130, a memory 1102, and high-speed wireless circuitry 1132. In some examples, the image display driver 1120 is coupled to the high-speed circuitry 1126 and operated by the high-speed processor 1130 in order to drive the left and right image displays of the image display of optical assembly 1118. The high-speed processor 1130 may be any processor capable of managing high-speed communications and operation of any general computing system needed for the head-wearable apparatus 716. The high-speed processor 1130 includes processing resources needed for managing high-speed data transfers on a high-speed wireless connection 1114 to a wireless local area network (WLAN) using the high-speed wireless circuitry 1132. In certain examples, the high-speed processor 1130 executes an operating system such as a LINUX operating system or other such operating system of the head-wearable apparatus 716, and the operating system is stored in the memory 1102 for execution. In addition to any other responsibilities, the high-speed processor 1130 executing a software architecture for the head-wearable apparatus 716 is used to manage data transfers with high-speed wireless circuitry 1132. In certain examples, the high-speed wireless circuitry 1132 is configured to implement Institute of Electrical and Electronic Engineers (IEEE) 802.11 communication standards, also referred to herein as WiFi. In some examples, other high-speed communications standards may be implemented by the high-speed wireless circuitry 1132.

The low-power wireless circuitry 1134 and the high-speed wireless circuitry 1132 of the head-wearable apparatus 716 can include short-range transceivers (Bluetooth™) and wireless wide, local, or wide area network transceivers (e.g., cellular or WiFi). Mobile device 714, including the transceivers communicating via the low-power wireless connection 1112 and the high-speed wireless connection 1114, may be implemented using details of the architecture of the head-wearable apparatus 716, as can other elements of the network 1116.

The memory 1102 includes any storage device capable of storing various data and applications, including, among other things, camera data generated by the left and right visible light cameras 1106, the infrared camera 1110, and the image processor 1122, as well as images generated for display by the image display driver 1120 on the image displays of the image display of optical assembly 1118. While the memory 1102 is shown as integrated with high-speed circuitry 1126, in some examples, the memory 1102 may be an independent standalone element of the head-wearable apparatus 716. In certain such examples, electrical routing lines may provide a connection through a chip that includes the high-speed processor 1130 from the image processor 1122 or the low-power processor 1136 to the memory 1102. In some examples, the high-speed processor 1130 may manage addressing of the memory 1102 such that the low-power processor 1136 will boot the high-speed processor 1130 any time that a read or write operation involving memory 1102 is needed.

As shown in FIG. 11, the low-power processor 1136 or high-speed processor 1130 of the head-wearable apparatus 716 can be coupled to the camera (visible light camera 1106, infrared emitter 1108, or infrared camera 1110), the image display driver 1120, the user input device 1128 (e.g., touch sensor or push button), and the memory 1102.

The head-wearable apparatus 716 is connected to a host computer. For example, the head-wearable apparatus 716 is paired with the mobile device 714 via the high-speed wireless connection 1114 or connected to the server system 1104 via the network 1116. The server system 1104 may be one or more computing devices as part of a service or network computing system, for example, that includes a processor, a memory, and network communication interface to communicate over the network 1116 with the mobile device 714 and the head-wearable apparatus 716.

The mobile device 714 includes a processor and a network communication interface coupled to the processor. The network communication interface allows for communication over the network 1116, low-power wireless connection 1112, or high-speed wireless connection 1114. Mobile device 714 can further store at least portions of the instructions for generating binaural audio content in the mobile device 714's memory to implement the functionality described herein.

Output components of the head-wearable apparatus 716 include visual components, such as a display such as a liquid crystal display (LCD), a plasma display panel (PDP), a light-emitting diode (LED) display, a projector, or a waveguide. The image displays of the optical assembly are driven by the image display driver 1120. The output components of the head-wearable apparatus 716 further include acoustic components (e.g., speakers), haptic components (e.g., a vibratory motor), other signal generators, and so forth. The input components of the head-wearable apparatus 716, the mobile device 714, and server system 1104, such as the user input device 1128, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 716 may also include additional peripheral device elements. Such peripheral device elements may include biometric sensors, additional sensors, or display elements integrated with the head-wearable apparatus 716. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1112 and high-speed wireless connection 1114 from the mobile device 714 via the low-power wireless circuitry 1134 or high-speed wireless circuitry 1132.

In order to detect or track expressions, gestures, motions, or other actions, as mentioned above, the head-wearable apparatus 716 may execute a machine learning model such as an object tracking model, according to some examples. The machine learning model may be executed at the head-wearable apparatus 716, at a host computer, or at an interaction server.

Generally, once a machine learning model has been built, e.g., as described with reference to FIG. 4 or FIG. 5, the model may be transmitted or otherwise made available to a user device (e.g., the mobile device 714, the head-wearable apparatus 716, or computer client device 718), to enable or facilitate such detections or tracking functions.

### Machine Architecture

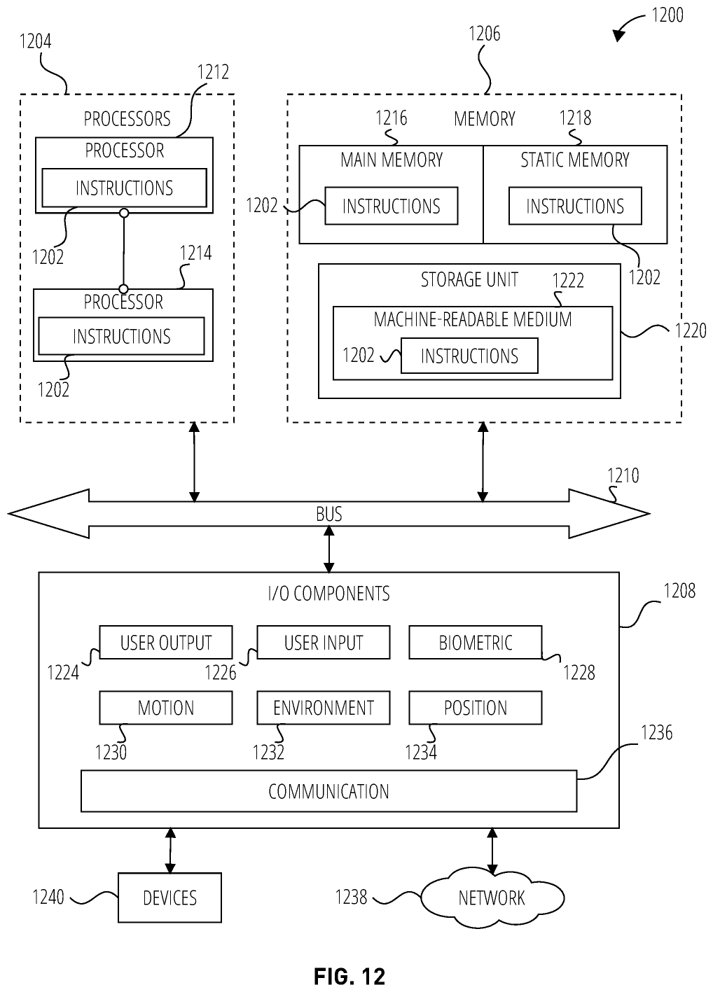

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the user system 702 or any one of multiple server devices forming part of the interaction server system 710. In some examples, the machine 1200 may also comprise both client and server systems, with certain operations of a particular method or algorithm being performed on the server-side and with certain operations of the particular method or algorithm being performed on the client-side.

The machine 1200 may include processors 1204, memory 1206, and input/output I/O components 1208, which may be configured to communicate with each other via a bus 1210. In an example, the processors 1204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1212 and a processor 1214 that execute the instructions 1202. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single-core, a single processor with multiple cores (e.g., a multi-core processor), multiple processors with a single core, multiple processors with multiples cores, or any combination thereof.

The memory 1206 includes a main memory 1216, a static memory 1218, and a storage unit 1220, both accessible to the processors 1204 via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1230 include acceleration sensor components (e.g., accelerometer), gravitation sensor components, rotation sensor components (e.g., gyroscope).

The environmental components 1232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 702 may have a camera system comprising, for example, front cameras on a front surface of the user system 702 and rear cameras on a rear surface of the user system 702. The front cameras may, for example, be used to capture still images and video of a user of the user system 702 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 702 may also include a 360° camera for capturing 360° photographs and videos.

Further, the camera system of the user system 702 may include dual rear cameras (e.g., a primary camera as well as a depth-sensing camera), or even triple, quad or penta rear camera configurations on the front and rear sides of the user system 702. These multiple cameras systems may include a wide camera, an ultra-wide camera, a telephoto camera, a macro camera, and a depth sensor, for example.

The position components 1234 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1208 further include communication components 1236 operable to couple the machine 1200 to a network 1238 or devices 1240 via respective coupling or connections. For example, the communication components 1236 may include a network interface component or another suitable device to interface with the network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the processors 1204) and storage unit 1220 may store one or more sets of instructions and data structures (e.g., software) embodying or used by any one or more of the methodologies or functions described herein. These instructions (e.g., the instructions 1202), when executed by processors 1204, cause various operations to implement the disclosed examples.

The instructions 1202 may be transmitted or received over the network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

### Software Architecture

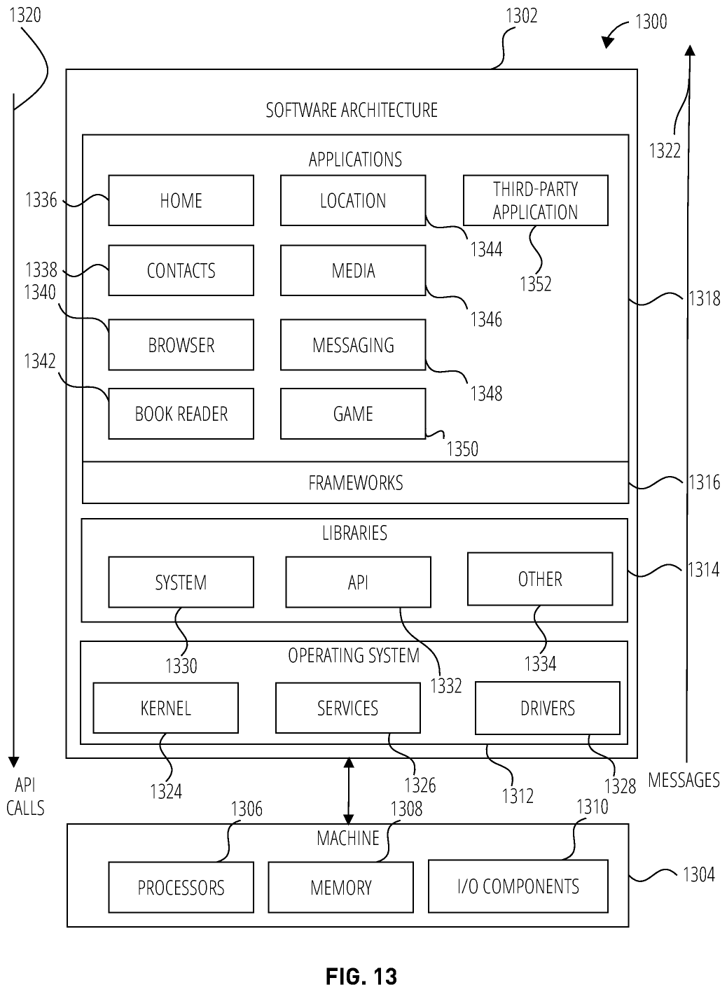

FIG. 13 is a block diagram 1300 illustrating a software architecture 1302, which can be installed on any one or more of the devices described herein. The software architecture 1302 is supported by hardware such as a machine 1304 that includes processors 1306, memory 1308, and I/O components 1310. In this example, the software architecture 1302 can be conceptualized as a stack of layers, where each layer provides a particular functionality. The software architecture 1302 includes layers such as an operating system 1312, libraries 1314, frameworks 1316, and applications 1318. Operationally, the applications 1318 invoke API calls 1320 through the software stack and receive messages 1322 in response to the API calls 1320.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 provides memory management, processor management (e.g., scheduling), component management, networking, and security settings, among other functionalities. The services 1326 can provide other common services for the other software layers. The drivers 1328 are responsible for controlling or interfacing with the underlying hardware. For instance, the drivers 1328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1314 provide a common low-level infrastructure used by the applications 1318. The libraries 1314 can include system libraries 1330 (e.g., C standard library) that provide functions such as memory allocation functions, string manipulation functions, mathematic functions, and the like. In addition, the libraries 1314 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1314 can also include a wide variety of other libraries 1334 to provide many other APIs to the applications 1318.

The frameworks 1316 provide a common high-level infrastructure that is used by the applications 1318. For example, the frameworks 1316 provide various graphical user interface (GUI) functions, high-level resource management, and high-level location services. The frameworks 1316 can provide a broad spectrum of other APIs that can be used by the applications 1318, some of which may be specific to a particular operating system or platform.

In an example, the applications 1318 may include a home application 1336, a contacts application 1338, a browser application 1340, a book reader application 1342, a location application 1344, a media application 1346, a messaging application 1348, a game application 1350, and a broad assortment of other applications such as a third-party application 1352. The applications 1318 are programs that execute functions defined in the programs. Various programming languages can be employed to create one or more of the applications 1318, structured in a variety of manners, such as object-oriented programming languages (e.g., Objective-C, Java, or C++) or procedural programming languages (e.g., C or assembly language). In a specific example, the third-party application 1352 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1352 can invoke the API calls 1320 provided by the operating system 1312 to facilitate functionalities described herein.

### CONCLUSION

According to examples of the present disclosure, a distributed framework addresses technical challenges of resource bottlenecks by separating CPU or IO (input/output) intensive workloads, such as data reading and data augmentation/preprocessing, from GPU intensive model training. In some examples, these workloads may be separated and executed by different processors and/or machines (virtual or physical). The machines may be separate and remote from each other.

GPUs can be designed for performing the complex mathematical and geometric calculations necessary for graphics rendering. Accordingly, in some examples, such as when an object tracking model is created, the architecture of examples of the present disclosure improves the utilization of GPU resources while ensuring that CPU and memory resources are used as desired, resulting in shortening of machine learning model training or total building time.

While the examples described herein focus on separating CPU and GPU workloads, according to other examples, other processing units such as TPUs (Tensor Processing Units) may be deployed instead of (or together with) GPUs, without departing from the present disclosure. (A TPU is an application-specific integrated circuit designed to accelerate artificial intelligence calculations and algorithms.)

When distributing and horizontally scaling data loading tasks as described herein, a technical challenge may arise in that requests from the trainer (client) must be routed efficiently and not, for example, only to one data loader or to a data loader that is “busier” than others. According to examples of the present disclosure, this challenge is addressed by implementing a service mesh in which proxies handle both incoming and outgoing calls, routing traffic so as to optimize or improve resource utilization. A service mesh includes a control plane, which is called by a data plane (defined by the proxies) to inform behavior of the data plane, and which provides an interface to allow a user to modify and inspect the behavior of the data plane.

While the examples described herein focus on object tracking models, the technique and method according to examples of the present disclosure can also be applied to the building of other types of machine learning models.

As used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology. “Communication network” and “communications network” may be used interchangeably.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1004) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors 1004. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and (and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Processor” refers, for example, to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A method comprising:
accessing, by one or more data loaders in a distributed computer system, input data from a storage component;
transmitting, by a trainer in the distributed computer system, a training data request, the trainer being communicatively coupled to the one or more data loaders, and the trainer and the one or more data loaders being executed on separate processors;
in response to receiving, by a data loader of the one or more data loaders, the training data request, executing, by the data loader, a data loading task, the data loading task including preprocessing an input batch read from the input data to generate a training batch;
transmitting, by the data loader, the training batch to the trainer; and
executing, by the trainer, a training task, the training task including using the training batch to execute a machine learning algorithm in a model building process.

2. The method of claim 1, comprising:
allocating Central Processing Unit (CPU) resources in the distributed computer system to the one or more data loaders; and
allocating Graphics Processing Unit (GPU) resources in the distributed computer system to the trainer, wherein the GPU resources are allocated such that each data loader does not utilize any of the GPU resources.

3. The method of claim 1, comprising:
deploying one or more network proxies such that communications between the trainer and the one or more data loaders are effected via a service mesh.

4. The method of claim 3, wherein the deploying one or more network proxies comprises defining a data plane of the service mesh by deploying each network proxy in unique association with either the trainer or the one or more data loaders, each network proxy being communicatively coupled to a control plane of the service mesh.

5. The method of claim 4, wherein the one or more data loaders is a plurality of data loaders, defining a one-to-many relationship between the trainer and the data loaders, each data loader being uniquely associated with one of the network proxies.

6. The method of claim 5, comprising:
transmitting, by the trainer, training data requests to each of the plurality of data loaders.

7. The method of claim 6, wherein the training data requests are transmitted using a Remote Procedure Call (RPC) protocol.

8. The method of claim 7, wherein the RPC protocol is gRPC.

9. The method of claim 5, wherein each data loader is a separate instance of a service in the distributed computer system.

10. The method of claim 6, comprising:
controlling, by the service mesh, traffic between the trainer and the plurality of data loaders.

11. The method of claim 6, comprising:
routing, by the network proxies, the training data requests to the data loaders so as to optimize utilization of the trainer.

12. The method of claim 11, wherein the routing comprises using an exponentially-weighted moving average of response latencies to determine to which one of the data loaders to transmit each training data request.

13. The method of claim 7, wherein the training data requests are service-to-service calls, the network proxy associated with the trainer being configured to load balance the training data requests across the plurality of data loaders.

14. The method of claim 4, wherein the trainer and each data loader is executed by a respective pod in the distributed computer system, each network proxy being a proxy container added to the pod of the trainer or the data loader associated with the network proxy.

15. The method of claim 1, wherein the one or more data loaders and the trainer are executed on different machines in the distributed computer system.

16. The method of claim 1, comprising:
implementing, by each data loader, a multi-producer, multi-consumer queue, the implementing comprising performing the preprocessing at least partially in parallel with a reading task, the reading task comprising fetching, by the data loader, one or more input batches from the storage component and adding the one or more input batches to a preprocessing queue of the data loader.

17. The method of claim 1, wherein the input data includes at least one of hand detection data, hand tracking data, gesture detection data, or gesture tracking data.

18. The method of claim 17, wherein the trainer is configured to transmit a plurality of additional training data requests in order to permit the training task to be iterated using a plurality of training batches generated from different input batches by the one or more data loaders, the method comprising generating, by the trainer, an object tracking model based on a result of the training tasks in the model building process.

19. A distributed computing system comprising:
one or more processors; and
a non-transitory computer readable storage medium comprising instructions that when executed by the one or processors cause the one or more processors to perform operations comprising:
accessing, by one or more data loaders in a distributed computer system, input data from a storage component;
transmitting, by a trainer in the distributed computer system, a training data request, the trainer being communicatively coupled to the one or more data loaders, and the trainer and the one or more data loaders being executed on separate processors;
in response to receiving, by a data loader of the one or more data loaders, the training data request, executing, by the data loader, a data loading task, the data loading task including preprocessing an input batch read from the input data to generate a training batch;
transmitting, by the data loader, the training batch to the trainer; and
executing, by the trainer, a training task, the training task including using the training batch to execute a machine learning algorithm in a model building process.

20. A machine-readable non-transitory storage medium having instruction data executable by a machine to cause the machine to perform operations comprising:
accessing, by one or more data loaders in a distributed computer system, input data from a storage component;
transmitting, by a trainer in the distributed computer system, a training data request, the trainer being communicatively coupled to the one or more data loaders, and the trainer and the one or more data loaders being executed on separate processors;
in response to receiving, by a data loader of the one or more data loaders, the training data request, executing, by the data loader, a data loading task, the data loading task including preprocessing an input batch read from the input data to generate a training batch;
transmitting, by the data loader, the training batch to the trainer; and
executing, by the trainer, a training task, the training task including using the training batch to execute a machine learning algorithm in a model building process.
